(19) United States
(12) Patent Application Publication
(10) Pub. No.: US 2016/0328526 A1
(43) Pub. Date: Nov. 10, 2016

(54) Case management system using a medical event forecasting engine

(71) Applicant: Accordion Health, Inc., Austin, TX (US)

(72) Inventors: Yubin Park, Austin, TX (US); Joyce Ho, Austin, TX (US); Sriram Vishwanath, Austin, TX (US)

(21) Appl. No.: 15/092,738

(22) Filed: Apr. 7, 2016

Related U.S. Application Data
(60) Provisional application No. 62/144,062, filed on Apr. 7, 2015.

(51) Int. Cl. G06F 19/00; G06N 5/04; G06N 99/00

(52) U.S. Cl. CPC G06F 19/345; G06N 99/005; G06F 19/3443; G06N 5/04

(57) ABSTRACT

A case management tool uses a novel event forecast engine. The engine leverages a flexible and extensible data structure that combines diverse formats of claims (e.g., both medical and pharmacy) and that highlights “episodes” rather than items. The engine also makes predictions with respect to “cohorts” groups, where cohorts are defined using both static and dynamic features, the latter being features that change their values based on observation periods. Multiple definitions of cohorts are implemented, and optimal cohort definitions are estimated. The engine uses rolling time window processing to extract dynamic features in the data sets, and then one or more machine learning algorithms are applied to the extracted data. Cohort-wise machine learning models preferably learn on dynamic features, which are then put together for final predictions. A validation step is applied when outcomes are later observed. Validation results update the cohort definitions as well as the model parameters.

### BACKGROUND

1. Technical Field

This application relates generally to data-driven analytics for case management tools used in the healthcare industry.

2. Brief Description of the Related Art

Today, many healthcare organizations, such as health insurance plans, managed care organizations, integrated delivery networks, and the like, hire case managers (or nurses) to properly navigate and guide patients to improve the quality of their care deliveries and lower the costs of care paths. These case managers take a list of patients, and call or message them, and track their statuses, typically using spreadsheets or Electronic Health Record (EHR) systems. Given the complex nature of patients' conditions and care paths, the problem of addressing specific needs of patients has been extremely challenging. Moreover, the current practice of case management has resulted in alarm fatigue to many patients, decreasing the customer satisfaction level for the health plan. Case management tools have often been incorporated into Population Health Management System (PHMS), and representative case management systems include, for example, Athena Health's athenaCoordinator, AllScripts Care Coordination tool, and many others.

Forecasting next medical events and costs is an extremely challenging task. Traditionally, predicting major medical events has involved aggregating medical and pharmacy claims to feed into either generalized linear models or tree-based prediction models. The performance of such approaches, however, often is far from being useful in practice. The major reasons for this poor performance are several fold. In this first instance, most medical and pharmacy claims are item- (or service-) based, as opposed to being episode-based. Further, when such claims are preprocessed to feed into predictive algorithms, episodic information is often lost in the process. For example, although it is easy to derive certain features (such as how many particular services have been performed during the period of observation), there is not always sufficient information to determine what types of events (or episodes) have occurred. Another problem is that the patient population is often heterogeneous. For example, diabetic and non-diabetic patients can react very differently to a certain type of interventions. Furthermore, people under a HMO plan often go through different types of care paths than, say, people under a PPO plan. Yet another problem is that predictive models are typically built based on an aggregated snapshot of data, e.g., claims from a certain time period of time (e.g. over an entire year) might be aggregated in order to build static features for predicting medical events. These coarse aggregations, however, mask how those features are changing over time.

These and other deficiencies in prior art medical event forecasting are addressed by the techniques of this disclosure.

### BRIEF SUMMARY

Accordingly, this disclosure provides for improvements to case management tools and systems through the use of a high-precision event forecast engine, which greatly enhances the case management process. The forecast engine preferably leverages a flexible and extensible form of data structure that combines diverse formats of claims (e.g., both medical and pharmacy) and that highlights “episodes” rather than items, where an episode is a collection of claims that happened within a specified time window. An “episode array” is an array of episodes that are ordered by time. In this approach, disparate claims are combined and summarized by member (patient), and the data structure makes it easier to discover episodic progression of medical events. As a further aspect, and to address the problem of patient heterogeneity that can bias results, the forecast engine preferably works with respect to “cohorts” or groups. In this aspect, the patient population is divided into multiple cohorts, where the definitions of cohorts typically involve various types of information, such as comorbidity conditions, geographic information, types of plans, logistical information, and combinations thereof. Cohorts preferably are defined using both static and dynamic features. “Static features” are features that relatively remain the same over time, such as gender, date of birth, address, and eligibility information. “Dynamic features” are features that change their values based on observation periods. These features include, for example, chronic conditions, medication profiles, risk scores, and utilization patterns. Preferably, multiple definitions of cohorts are implemented, and optimal cohort definitions are then estimated through iterative validations. In particular, the forecast engine uses rolling time window processing to extract dynamic features in the data sets, and then one or more machine learning algorithms are applied to the extracted data. Preferably, predictions are blended to reduce bias, and cohort-wise machine learning models preferably learn on dynamic features, which are then put together for final predictions. Subsequently, a validation step is applied when outcomes are later observed in the future. The results of the validation operation may then be used to update the cohort definitions as well as the model parameters for the machine learning algorithms.

The predictions generated by the forecast engine provide for an improved case management system that facilitates case management on a per-patient basis. In particular, the machine learning (ML) algorithms predict, for example, which events are coming next, when those events will happen, and the like, and they enable the case manager to obtain or provide other useful care information, e.g., to simulate risk trajectories for different care path options, prioritize a list of patients that need help, track prior interventions (phone call, text message, mail, etc.), share intervention histories with different case managers, analyze the effectiveness of the interventions, and analyze the performance of case managers.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 depicts a conventional hospital-based case management system;

FIG. 2 depicts the improved case management system of this disclosure that is driven by an episode-driven, cohort-wise forecast engine;

FIG. 3 depicts a representative data structure object for an episode;

FIG. 4 depicts an episode array data structure object;

FIG. 5 depicts a member data structure object;

FIG. 6 depicts the basic components of the forecast engine of this disclosure;

FIG. 7 depicts how the validation operation may be used to adjust cohort groupings;

FIG. 8 is a process flow that depicts the basic operation of the forecast engine;

FIG. 9 is a process flow that depicts the operation of the cohort grouper shown in FIG. 8;

FIG. 10 is a process flow that depicts the operation of the temporal feature extractor shown in FIG. 10;

FIG. 11 depicts how cohort information derived by the cohort grouper function may be used to update or augment a member data object;

FIG. 12 depicts how dynamic features change their values depending on observation periods;

FIG. 13 illustrates how rolling windows are used by the forecast engine to extract dynamic features that evolve over time;

FIG. 14 depicts the feature extraction and machine learning operations in additional detail as applied in this example scenario;

FIG. 15 depicts another example scenario and the rolling window technique;

FIG. 16 depicts the processing a feature matrix by the machine learning models;

FIG. 17 depicts a first case management system interface display driven by the forecast event engine of this disclosure;

FIG. 18 depicts a web interface for the case management tool by which a case manager may generate a customized chase list of patients as generated by the forecast engine;

FIG. 19 depicts how a given row in the chase list may be selected to reveal additional options;

FIG. 20 depicts a demographic information display panel in the web interface;

FIG. 21 depicts a timeline view of a display panel of predicted events for the patient as generated by the forecast engine;

FIG. 22 depicts a display panel showing predicted outcomes for different care path scenarios for the patient as generated by the forecast engine;

FIG. 23 depicts a display panel by which a case manager can enter information captured during member communications; and

FIG. 24 depicts a usage dashboard by which a case manager can review trends, statistics, reports, and the like.

### DETAILED DESCRIPTION

By way of background, the techniques of this disclosure may be implemented in a case management system or tool. A typical case management system is a collection of various computing machines or infrastructure that is network-accessible, and that supports various display interfaces. Further details of a case management system user interface that is enhanced by the forecast engine of this disclosure are provided below.

As is well-known, case management is a managed care technique within the health care coverage system of the United States. Typically, and from a health care perspective, case management is defined as a collaborative process of assessment, planning, facilitation, care coordination, evaluation, and advocacy for options and services to meet an individual's and family's comprehensive health needs through communication and available resources to promote quality cost effective outcomes.

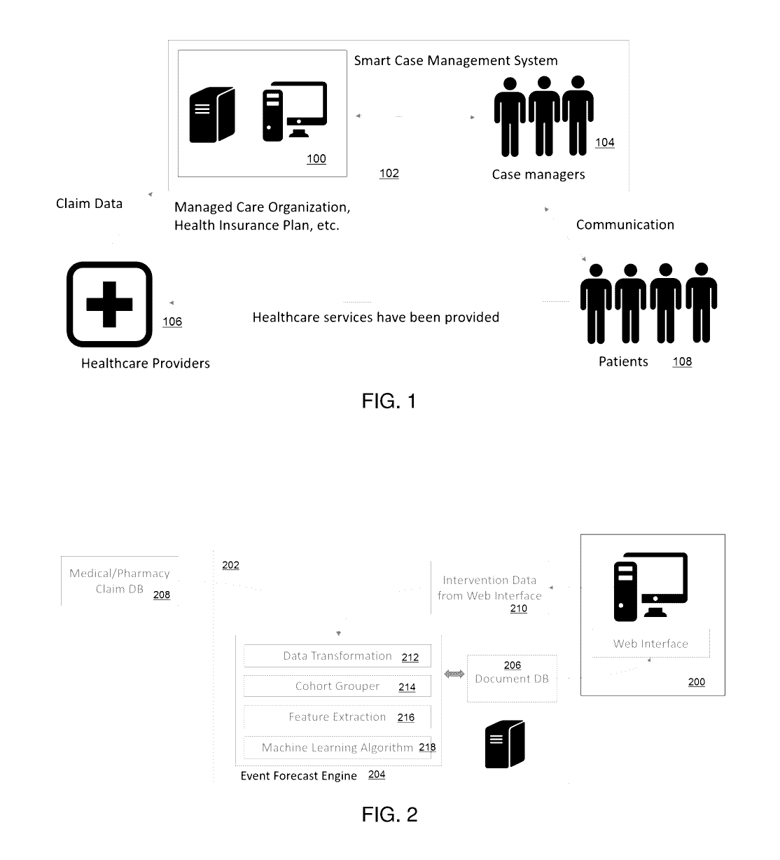

A representative case management tool 100 is depicted in FIG. 1 in the context of a case management system 102 that includes case managers 104. When the case management tool is implemented in a hospital setting for example, the case managers 104 are professionals who ensure that patients 108 are admitted and transitioned to the appropriate level of care, have an effective plan of care and are receiving prescribed treatment, and have an advocate for services and plans needed during and after their stay. Case managers 104 concurrently plan for transitions of care, discharge and often post discharge follow up. Case managers often coordinate/communicate with the patient and family, physician(s), and funding sources (i.e. insurance, Medicare) 106. Through this coordination, hospital case managers' goals are to ensure both optimal patient and hospital outcomes including quality of care, efficient resource utilization and reimbursement for services. Of course, the hospital is not the only healthcare environment wherein case management used. Case managers in those other environments may have different tasks and obligations, but the basic concepts are similar. In the context of this disclosure, it is assumed that the case management system exists and that there is a desire to improve that system.

FIG. 2 is a block diagram of a case management system 200 that is improved by an event forecast system 202. The event forecast system 202 comprise an event forecast engine 204, and a document database 206 that preferably structures data in a format, as will be seen. As shown, the forecast engine 204 preferably comprises a set of components, namely data transformation component 212, cohort grouper component 214, feature extraction component 216 and machine learning component 218. These components are shown separately, but the functions may be combined in whole or in part. Typically, each component is implement as software, namely, as set of computer program instructions, executed in one or more hardware processors. The components may be co-located or distributed. As depicted, the event forecast engine 204 preferably executes as a “front-end” to the case management system 200 and its associated web-based interface 220. The event forecast engine 204 may execute in association with the case management system 200 or as a distinct mechanism, as the notion of case management itself does not imply or require any prediction capability. A preferred implementation is that the event forecast engine is integrated with the case management system, which management system may be integrated in some larger computing infrastructure. The various components depicted (in whole or in part) may be implemented in or as standalone computing machines, part of an enterprise computing infrastructure, or within a distributed or cloud-based architecture (as physical or virtual machines).

As depicted, in addition to data provided from the document database 206, the event forecast engine 204 receives various input data including medical/pharmacy claim data from a medical/pharmacy claim database 208, as well as patient intervention data 210 that is provided from the case management tool. This data may be input to the event forecast engine, or it may be provided programmatically (via an API), or in any other convenient manner. Medical claims typically include claims from inpatient, outpatient, skilled nursing, home health, and other non-pharmacy events. Pharmacy claims typically include prescription medication fill events. Pharmacy claims typically have 30, 60, 90 days of service periods. Typically, medical and pharmacy claims are grouped separately. These data may be provided from other sources, and these data sources may comprise part of the event forecast engine.

In general, and as will be seen, the event forecast engine operates in one or more domains (or use cases). A primary application is for patient targeting. In this use case, the engine is used to identify a subset of a population who will likely go through a certain medical event, e.g. surgery or disease, at some point in the future. Preferably, the engine provides different forecasting results calibrating user's demographic and medical history information. In this use case, the engine forecasts the next events and the “time” of the events.

The data transformation component (or “data transformer”) 212 preferably takes multiple sources of claims data and member demographics data to construct a member-level view of the data. Extracting a member-level view of the data is non-trivial. Each claim source typically has a different list of variables, and even the definitions of the variables are different. For example, inpatient claims may use ICD-9 codes to record procedures that are performed, while outpatient claims may use HCPCS codes. Moreover, inpatient claims may have additional variables, such as length of stay and Diagnosis Related Group codes, where outpatient claims have no such variables. Putting multiple sources of claims into a single table can be difficult, as a system would need to create an un-manageable number of variables (or columns in a table view); indeed, even after doing so, analyzing such data may be quite difficult. To address this issues, the data transformer 212 merges such multiple sources to construct a member-level view of the data, preferably by using a flexible data representation (such as a JSON format), together with the notion of an “episode” that combines multiple claim items into one.

Thus, the event forecast engine 204 operates with data that is based on “episodes,” as opposed to events. As used herein, an “episode” is a collection of claims that happen within a specified time window e.g. a day, three days, etc. The time window is configurable. An “episode array” is an array of episodes that are ordered by time. Preferably, the document database 206 associated with the event forecast engine organizes data in a manner that can advantage of the data points that comprise an episode. While multiple tables and complex relations (e.g., those provided in relational database management systems) often are necessary to represent different types of claims, organizing data relationally obfuscates episodic information. Because the event forecast engine preferably operates over episode data, the document database 206 preferably is structured to contain different types of events in a concise view. A preferred implementation of the document database 206 thus is a class of NoSQL databases and, even more preferably, one that stores data in so-called JSON (JavaScript Object Notation) formats.

JSON is a lightweight, text-based, language-independent data-interchange format that is used with Asynchronous JavaScript and XML (collectively referred to as AJAX), which are well-known technologies that allow user interaction with Web pages to be decoupled from the Web browser's communications with a Web server. AJAX is built upon dynamic HTML (DHTML) technologies including: JavaScript, a scripting language commonly used in client-side Web applications; the Document Object Model (DOM), a standard object model for representing HTML or XML documents; and Cascading Style Sheets (CSS), a style sheet language used to describe the presentation of HTML documents. In AJAX, client-side JavaScript updates the presentation of a Web page by dynamically modifying a DOM tree and a style sheet. In addition, asynchronous communication, enabled by additional technologies, allows dynamic updates of data without the need to reload the entire Web page. These additional technologies include an application programming interface (API) that allows client-side JavaScript to make HTTP connections to a remote server and to exchange data, and JSON. JSON syntax is a text format defined with a collection of name/value pairs and an ordered list of values. By structuring the document database to support JSON formats, the event forecast system 202 is organized to interact with the data sources programmatically and over typical network request-response flows.

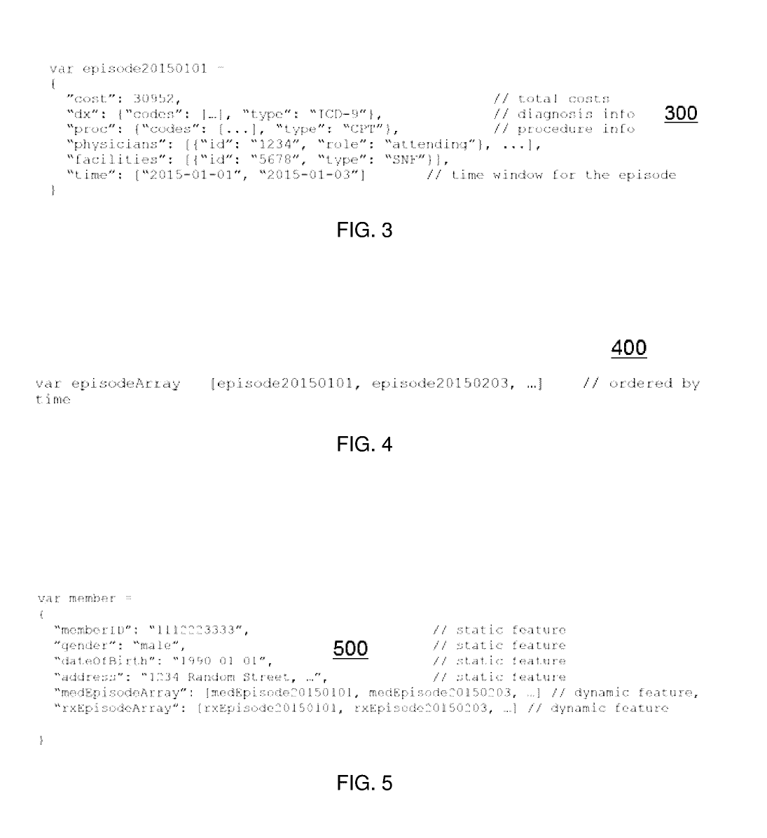

The document database includes various data structures that are populated by the data received from the data sources. Thus, for example, FIG. 3 depicts a representative data structure 300 for an episode according to an embodiment. In other words, an episode preferably is represented in the database as a data object. FIG. 4 depicts a representative “episode array” 400, which as noted is an array of episodes that are ordered by time. FIG. 5 depicts a representative data structure 500 for a member data object. Information about a member may include both “static” features, and “dynamic” features. “Static features” are features that relatively remain the same over time such as gender, date of birth, address, and eligibility information. “Dynamic features” are features that change their values based on observation periods. These features include chronic conditions, medication profiles, risk scores, and utilization patterns.

As can be seen, the member/patient data object 500 depicts multiple input sources into a “member-level view,” which as used herein refers to a collection of episodes that are related to a specific member. The merging of multiple data sources into a single data set (such as provided herein) has not been possible or efficient in prior art relational-based schemes, primarily due to the highly disparate nature of the variables used to define each of the data sources. In contrast, by gathering different sources of inputs and summarizing them at member-level as provided herein, data can be stored much more efficiently (in the document database 206) and acted upon by the feature extraction function 216 to identify dynamic features that have real predictive value.

The data objects are shown in FIGS. 3 and 5 as distinct, but they (or portions thereof) may be combined. There may be other types of data structures that comprise the document database. As a further aspect, information constituting one or more patient episodes may be transformed prior to or after being stored in a data structure. Representative episode transformations include merging first and second claims when the service periods the claims perfectly overlap, absorbing a first claim (by a second claim) when the service period of a first claim is a subset of the service period of the second claim, stitching together first and second claims when the service periods of the claims partially overlap, and so forth. Episode transforms thus may reduce the size of the document database.

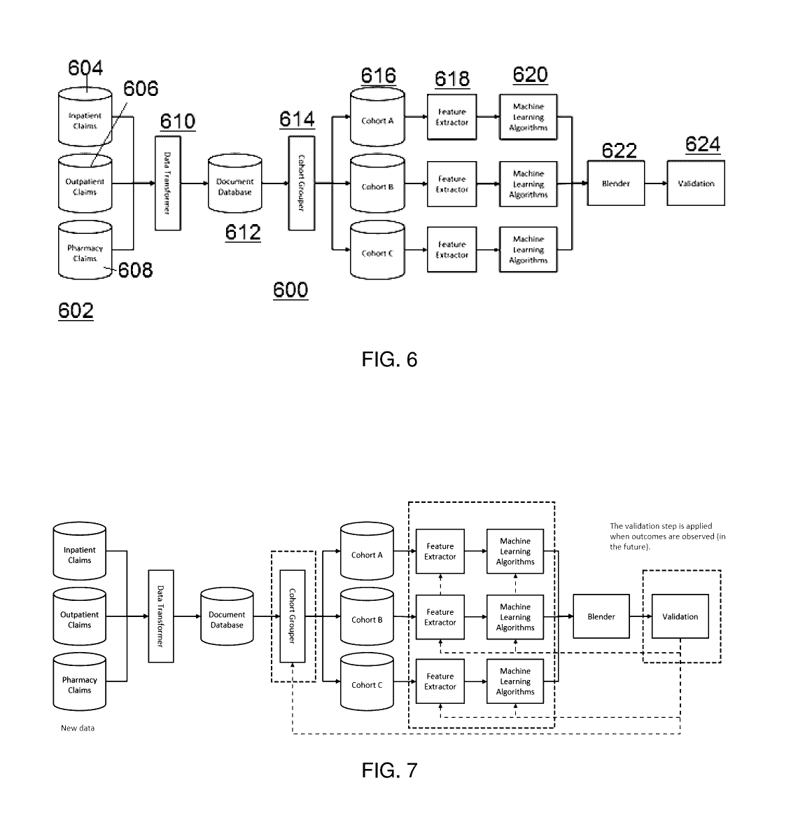

FIG. 6 depicts a preferred architecture of the event forecast engine 600. As noted above, the various components are broken out by function, but one or more of these functions may be combined in whole or in part. The functions typically are implemented in software executed in hardware processors. As shown, the data sources 602 (which may or may not be part of the system) provide the raw data used by the engine. That data includes inpatient claims 604, outpatient claims 606, and pharmacy data 608. The data from the input sources is applied through a data transformer 610 to generate the data structure objects such as described above. The data transformer 610 takes traditional medical and pharmacy claim formats (e.g., 837, CMS, etc.), normalizes the data, and populates the data structures. Preferably, the result is a set of member-level JSON documents, as represented by the data structure objects. The collection of member-level JSON documents are stored in the document database 612. A representative NoSQL database that may be used for this purpose is MongoDB. Information in the document database 612 is then acted on by the cohort grouper 614, which generates “cohorts” 616 such as Cohort A, Cohort B and Cohort C. As noted above, as used herein, a “cohort” can be defined in various ways, for example, using both static and dynamic features. Thus, for example, static cohorts may comprise members in Texas, male members, etc., while dynamic cohorts might comprise, for example, diabetic cohort (derived based on episodes for a given period of time), patients who visited Dr. Jones, patients who were admitted to Seton hospitals, etc. A mix of static and dynamic cohorts might then be a diabetic cohort in Texas. Of course, these are merely representative examples.

As will be seen, the forecast engine operates generally among numerous cohort definitions (e.g., that include Cohorts A, B and C) to find a set of optimal cohort definitions 616, preferably (as will be described) by iteratively validating prediction results. To this end, cohort information is first processed by the feature extractor 618. As depicted, preferably there is a feature extractor instance for each cohort, although a single instance may be used. The output of the feature extractor 618 for each cohort 616 is then supplied to one or more machine learning (ML) algorithms 620, and typically there will be multiple ML instances, with one instance per cohort processing thread as depicted. In general, the forecast engine operates as follows. Preferably, cohorts are defined using both static and dynamic features. Preferably, multiple definitions of cohorts are implemented, such as depicted. As will be explained in more detail below, the feature extractor 618 extracts static, dynamic, and dynamic features with rolling windows, and then one or more of the machine learning algorithms 620 are applied to the extracted data. Preferably, and to reduce bias, predictions output from the ML algorithms 620 are blended by a blender component 622. In operation, the cohort-wise machine learning models 620 preferably learn on dynamic features, which are then put together by the blender component 622 for final predictions. Subsequently, a validation step 624 is applied (when outcomes are later observed in the future).

As depicted in FIG. 7, the results of the validation operation 624 may then be used to update model parameters for machine learning algorithms as well as cohort definitions. In other words, according to this disclosure the optimal cohort definitions are estimated through iterative validations. As used herein, the term “optimal” may be a relative one, as opposed to some absolute value.

Thus, according to the techniques herein, disparate claims preferably are combined and summarized by member. The data formats make it easier to discover episodic progression of medical events. A collection of member-level JSON documents are stored in a NoSQL database. Static, dynamic, and dynamic features with rolling windows are extracted. Dynamic features with rolling windows have strong predictive power. Optimal cohorts are iteratively-learned, preferably by updating machine learning model parameters as well as cohort definitions.

Enabling technologies for the machine learning algorithms 624 for the forecast engine include, without limitation, vector autoregressive modeling (e.g., Autoregressive Integrated Moving Average (ARIMA)), state space modeling (e.g., using a Kalman filter), a Hidden Markov Model (HMM), recurrent neural network (RNN) modeling, RNN with long short-term memory (LSTM), Random Forests, Generalized Linear Models, Extreme Gradient Boosting, Extreme Random Trees, and others. By applying these modeling techniques, new types of features are extracted, e.g., as follows: model parameters (e.g. coefficients for dynamics, noise variance, etc.), latent states, and predicted values for a next couple of observation periods. These features have strong predictive power.

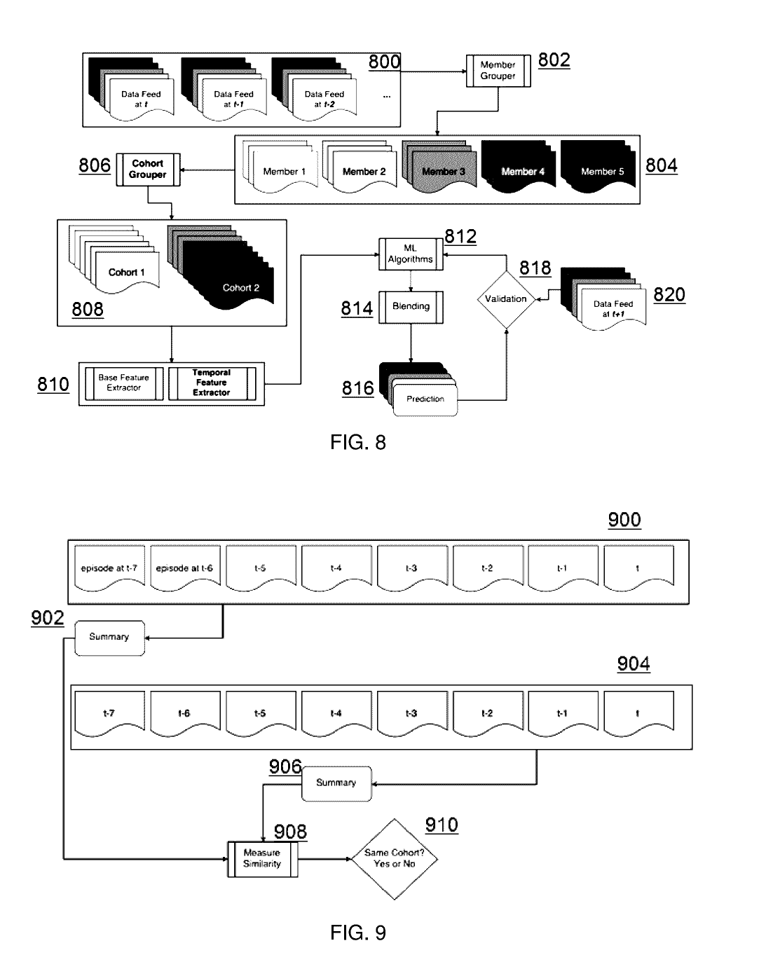

FIG. 8 depicts the overall system architecture with emphasis on the relevant data structures and their processing with the event forecast engine. Various data feeds 800 represent claims received in the system at different times (e.g., presently, weekly, monthly, etc.) These data feeds are grouped by member by a member grouper function 802. The output of the member grouper 802 is a set of data 804 for each patient. The member data is supplied as an input to the cohort grouper 806, which operates to parse the data and identify cohorts 808. The cohorts 808 are supplied as input to the feature extractor 810, which comprises a base feature extractor, and a temporal feature extractor. The base feature extractor output cohort-level base features, which typically are static (e.g., age, gender, etc.), while the temporal feature extractor outputs cohort-level temporal (i.e., dynamic) features. Although not depicted, the feature extraction (both base and temporal) may also be applied on the member data itself (i.e., without reference to the cohorts), as such non-cohort-specific data may also be used by the machine learning algorithms. Both the cohort-level base and temporal features, and optionally both the non-cohort derived base and temporal features, are then supplied to one or more machine learning algorithms 812, which apply such inputs against one or more machine learning models. A machine learning algorithm 812 operates by building a model from the example inputs in order to make data-driven predictions or decisions (rather than following strictly static program instructions). The outputs from machine learning algorithms 812 re then grouped together by blender 814 to reduce bias, which results in a set of predictions 816. The blending operation may be omitted, and there is no requirement that multiple machine learning algorithms 812 be used. In a simple approach, or where computational resources are constrained, just a single ML algorithm may be used to produce the predictions.

The predictions may be validated using a validation function 818. As described above with respect to FIG. 7, the outputs of the validation may then be feedback to adjust both the cohort definitions and the machine learning models. New data sources 820 may be used to facilitate the validation process.

FIG. 9 depicts the operation of the cohort grouper function, which operates to build up and maintain the cohorts. A set of cohorts 904 is assumed, as described by a summary 906. The function receives as input an episode array 900 and generates a summary 902. A similarity measure 908 compares the episode array with the existing cohorts to determine if there is measure of similarity. If the test 910 indicates a sufficient degree of similarity, the episode array is added to the cohort.

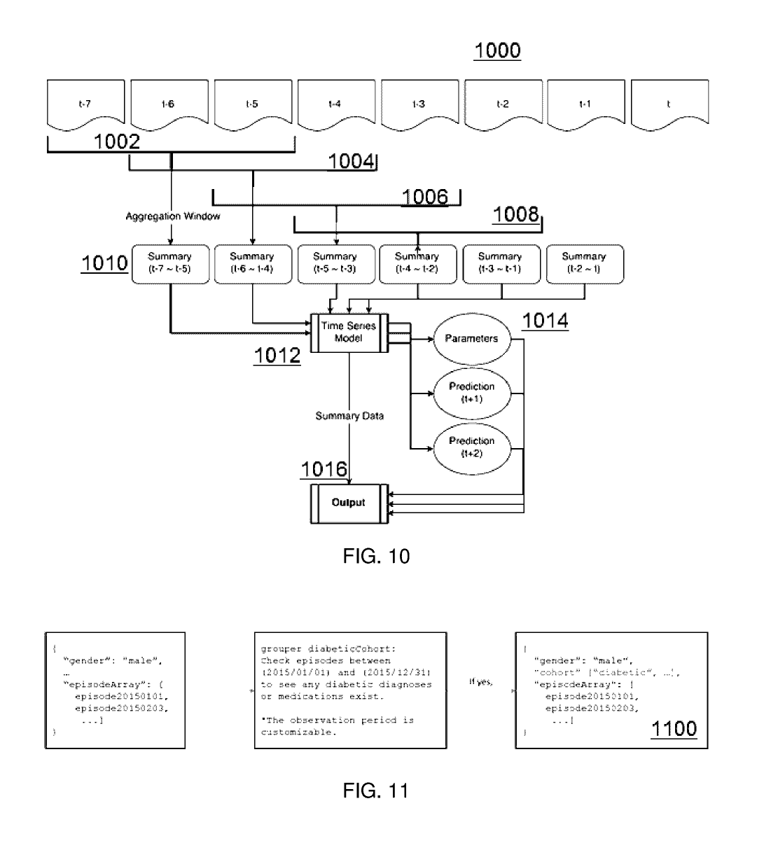

FIG. 10 depicts the operation of the feature extraction function. Further details of this function are provided below. The inputs are the cohorts 1000. Using a rolling time window (whose period is configurable), a number of aggregation windows 1002, 1004, 1006 and 1008 are applied to the cohort data to generate temporal-based summaries 1010. These summaries are the supplied as inputs to a time-series model 1012, which generates a set of model parameters and predictions 1014 (as defined in more detail below) that reflect the base and temporal features extracted. The extracted data is combined with summary data supplied by the time-series model to generate outputs 1016 that are then supplied to the machine learning algorithms, as previously described.

The cohort data extracted by this feature extraction process may then be used to update the member data structure object and, in particular, by adding the extracted cohort(s) as new features to the member object. FIG. 11 depicts this process, with the “diabetic” cohort being added to the member data object 1100.

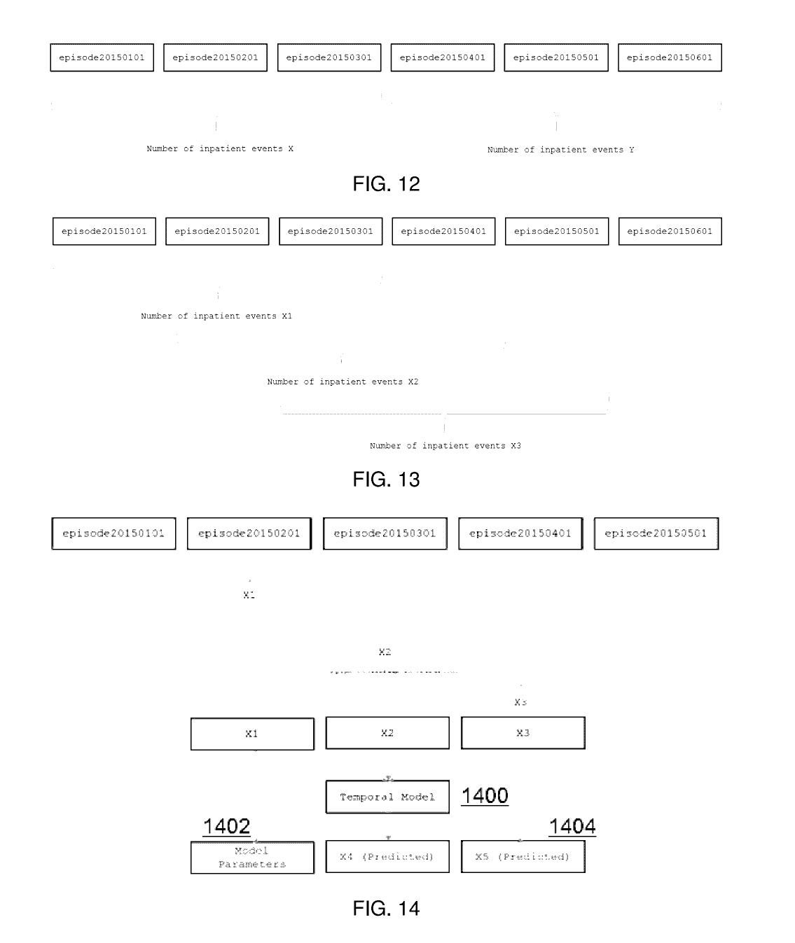

The dynamic feature extraction using rolling windows (DFRW) technique is now described in further detail. The technique relies upon the notion that dynamic features change their values depending on observation periods. For example, and as depicted in FIG. 12, a number of inpatient events can be different depending on which year the count was measured. In this example, the number X of inpatient events is different from the number Y of inpatient events. FIG. 13 depicts how rolling time windows are used to extract features that evolve over time. Using this approach, various time-series data are extracted by varying the size of windows, and types of features. Some examples of time-series data, which may be numeric or categorical, include: HCC (Hierarchical Condition Category), a risk score for the time window (numeric), Number of inpatient events (numeric), Number of COPD inpatient events (numeric), Length of stays during hospitalization (numeric), Chronic condition group (categorical), Most expensive diagnostic group (categorical), Most expensive medication group (categorical), Most expensive facility (categorical), and others. These time-series sequences are then modeled using the machine learning algorithms. By applying these modeling techniques, and as described, new types of features are then extracted, such as model parameters (e.g. coefficients for dynamics, noise variance, etc.), latent states, and predicted values for one or more upcoming observation periods.

FIG. 14 shows the operation of the feature extractor and machine learning on this example scenario. In this example, X1 is a vector of extracted temporal features from the time window of January 2015 to March 2015. X2 is a vector of extracted temporal features from the time window of February 2015 to April 2015, and so forth. The vectors X1, X2, X3, etc. are supplied to the temporal model 1400, which represents a machine learning model. Machine learning models that are based on time-series models (such as RNN, autoregressive models, Kalman filters, Hidden Markov Models, etc.) are preferred, and these models output two additional feature sets, namely, the model parameters 1402 and predicted values 1404 (e.g., X4 and X5). As previously described, some example model parameters 1402 include transition probabilities between events, drift parameters, latent representation of the time series, and the like. The temporal model 1400 (and there may be multiple such models) extrapolates (or forecasts) the next steps. These extrapolated values X4 and X5 may be the actual predictions provided to drive the case management tool, and they may also be used in a subsequent stage of the modeling process.

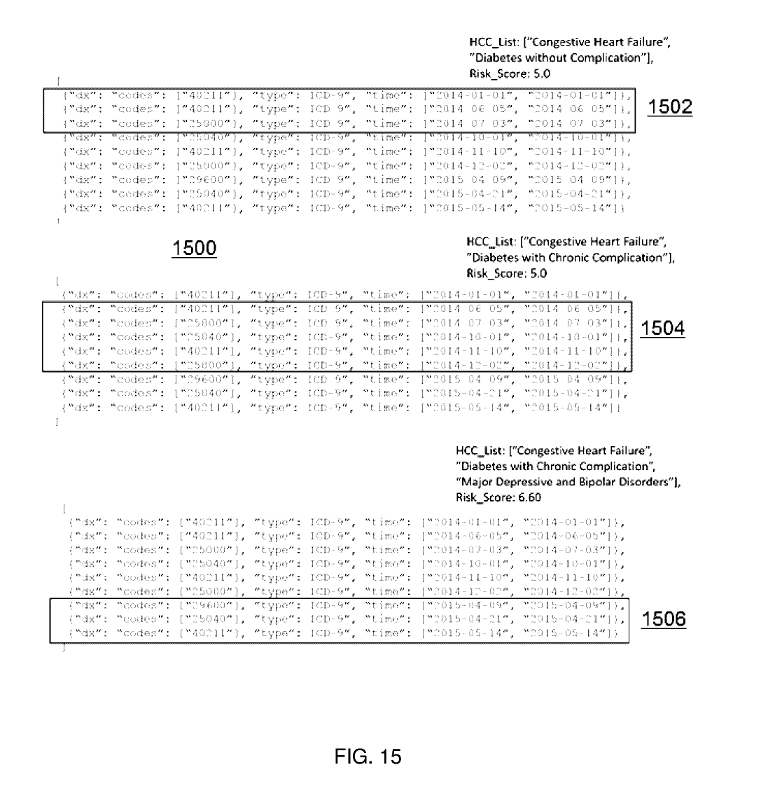

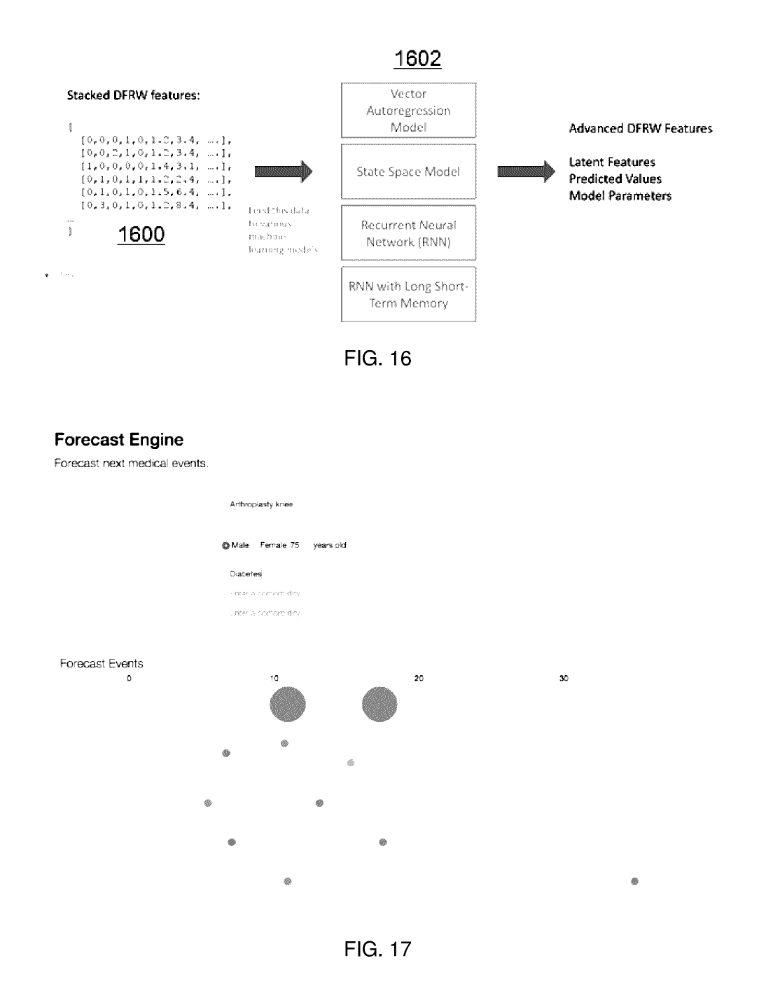

FIG. 15 depicts another example of the rolling window function on a particular data set. Consider a patient that has the depicted episode array 1500. As can be seen, there are nine (9) episodes from January 2014 to May 2015. From this data, the feature extractor extracts (using rolling time windows) Hierarchical Condition Categories. The first time window 1502 ranges from January 2014 to September 2014 (9 months). All the events within this time window are summarized using Hierarchical Condition Categories (HCC) in this example. The list of diagnosis codes, [40211, 25000], are converted to two HCC categories, and one risk score. The second window 1504 ranges from July 2014 to March 2015 (9 months) by moving 6 months from January 2014. All the events within this time window are summarized using Hierarchical Condition Categories (HCC) in this example. The list of diagnosis codes, [40211, 25000, 25040], are converted to three HCC categories, and one risk score. The last time window 1506 ranges from April 2015 to December 2015 (9 months) by moving 6 months from July 2014. All the events within this time window are summarized using Hierarchical Condition Categories (HCC) in this example. The list of diagnosis codes, [40211, 25600, 25040], are converted to three HCC categories, and one risk score. As depicted in FIG. 16, each patient would have his or her own feature matrix 1600. Some patients may have more records than others. The number of rows of the matrix is variable. The number of columns of the matrix is fixed. After feeding this matrix features to the one or more models 1602, various additional features (such as latent representation of the data, predicted values for the future events, model parameters (such as transition probabilities, drift momentum, etc.)) are then output for use by the case management system. In addition, the matrix may be augmented with these new features, and the features may also be fed to a machine learning algorithm in a next stage. Thus, the machine learning may occur serially (the output of one algorithm driving another model, in parallel (multiple outputs being generated), or by combinations of such machine learning.

Generalizing, the forecast engine extracts two types of signals from the multiple data sources that are supplied, namely, a before-pattern (a temporal pattern that leads to an event of interest), and an after-pattern (a temporal pattern that happens after an event of interest). Preferably, and as has been described, the patterns are customized to cohorts, such as demographic cohorts. For a new patient, both before and after patterns preferably are calibrated to match the new patient's demographic and medical history information. Typically, the patterns have different application domains. For example, before-patterns are used to target or predict a specific group of patients, and after-patterns are used to evaluate future outcomes and utilizations.

As has been described, extracting before-patterns typically involves a multiple step process. The time series data is first aligned, e.g., by setting the event of interest as a reference point. The time series is then clustered based on similarities. In an example scenario, the similarity is calculated based on multiple factors: similarity in previous medical events, similarity in the sequence of medical events, and similarity in the timestamps of medical events. For the extracted clusters, the patterns are generalized, preferably by being expressed as a function of demographic and medical history information. For a new patient, the engine can scan the extracted patterns and find a best match. The engine can also calculate the probability of following this pattern.

Extracting after-patterns also is a multi-step process. The time series data is first aligned, e.g., by setting the event of interest as a reference point (but this time right to left). The next step is removing noisy patterns (or non-causal patterns). The non-causal patterns are identified by comparing the likelihoods of after-patterns between the target population and the overall population. The extracted patterns are clustered, e.g., to a tree structure. Similar events (similar in both time and event type) may be grouped as a branch, then this process is recursively applied, resulting in a tree diagram. After constructing a tree, the strengths of branches and event times are expressed as a function of a patient's demographic and medical history information.

An improved case management system uses the above-described forecast engine as a predictive processing component. As noted above, the notion of case management does not imply or require any such prediction; thus, the inclusion of the forecast engine provides an improvement to another technology (the case management system or tool itself) or technical field (automated case management). In particular, the forecast engine provides for an improvement to the case management system be depicting the multiple disparate input sources in a member-level view from which feature extraction is performed, preferably using the rolling window technique. The outputs of the modeling include various additional features (such as latent representation of the data, predicted values for the future events, model parameters (such as transition probabilities, drift momentum, etc.)), which may then be used by the case management system.

FIG. 17 depicts one representative use case of the forecast engine. In this example, the case manager identifies the member's current issue, provides static inputs, and identifies one or more additional comorbidities exhibited by the patient. The events forecast by the modeling are then displayed, e.g., using a tree diagram to visualize forecasted medical pathways based on the input constraints.

As noted, the forecast engine-driven case management system is used to provide for an improvement case management system. It is assumed that the forecast engine is executing or has been executed to generate predictions, additional model parameters, etc., as has been described. The forecast engine may operate continuously, periodically, in response to a condition or occurrence, or otherwise. As noted, the engine transforms multiple sources in a member-level view and extracts dynamic features using rolling time windows to provide for enhanced predictions. In one aspect, the case management system uses such information to enable case managers (or other administrators) to generate a “chase list” of patients who are anticipated (predicted) to have future events.

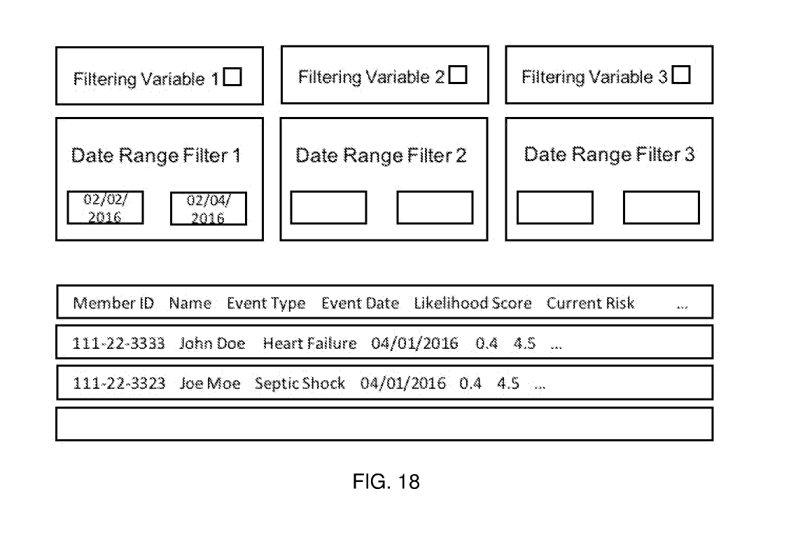

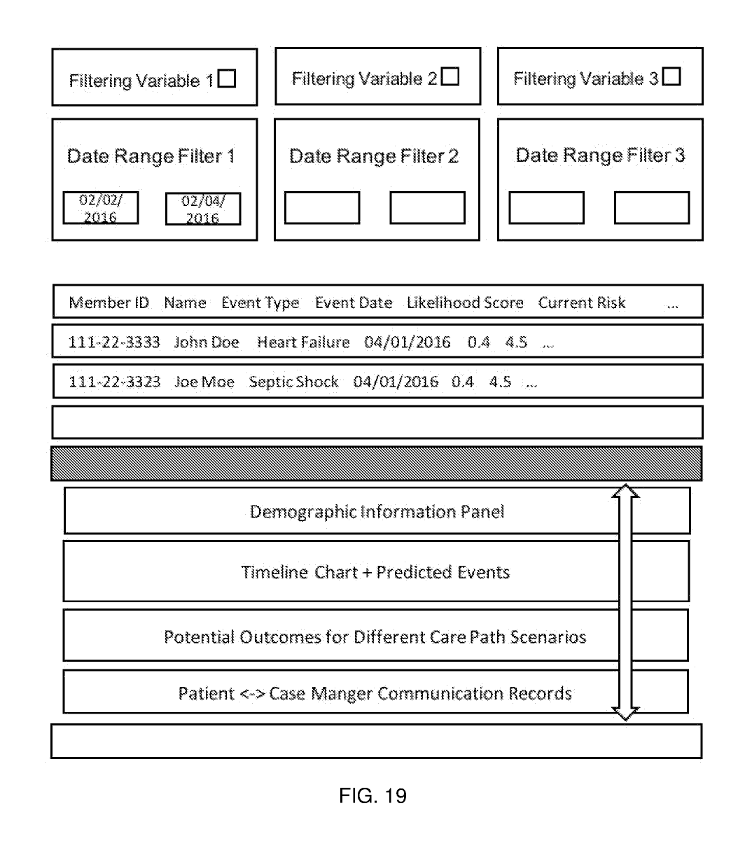

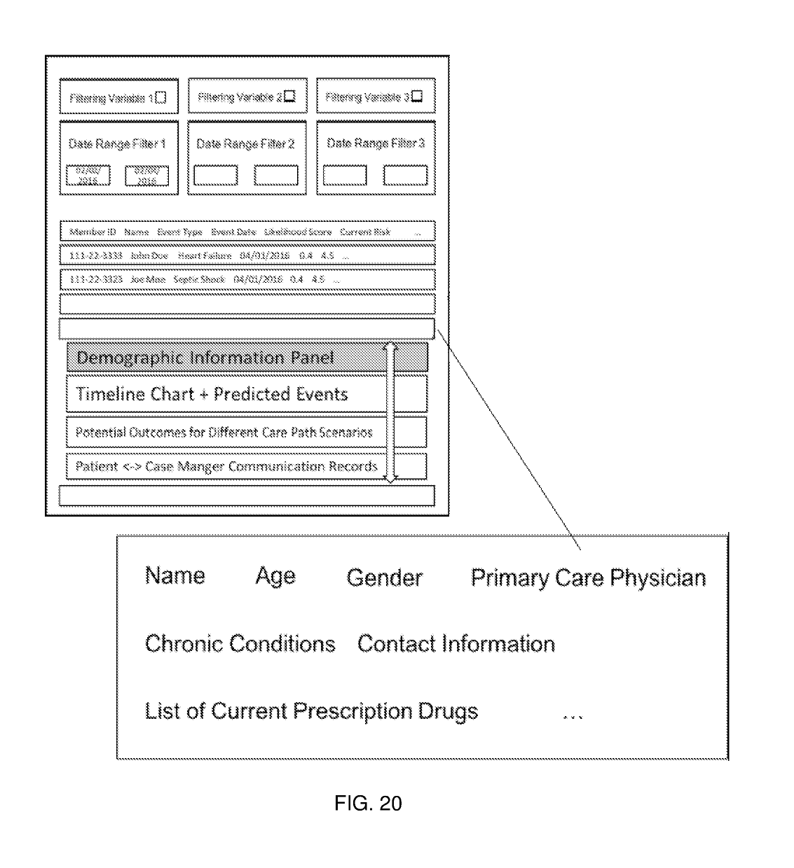

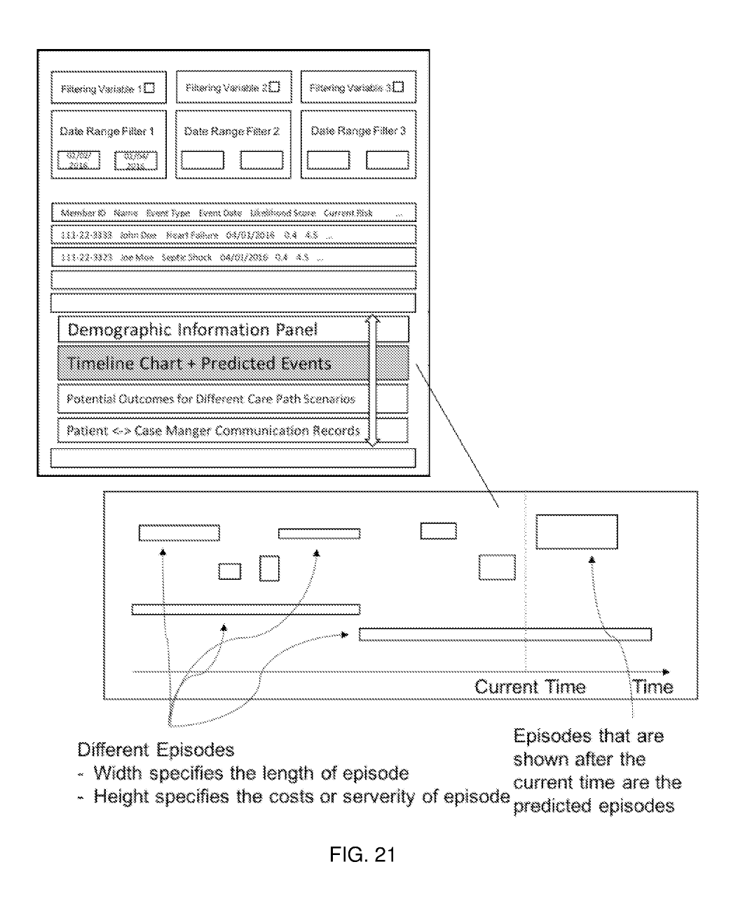

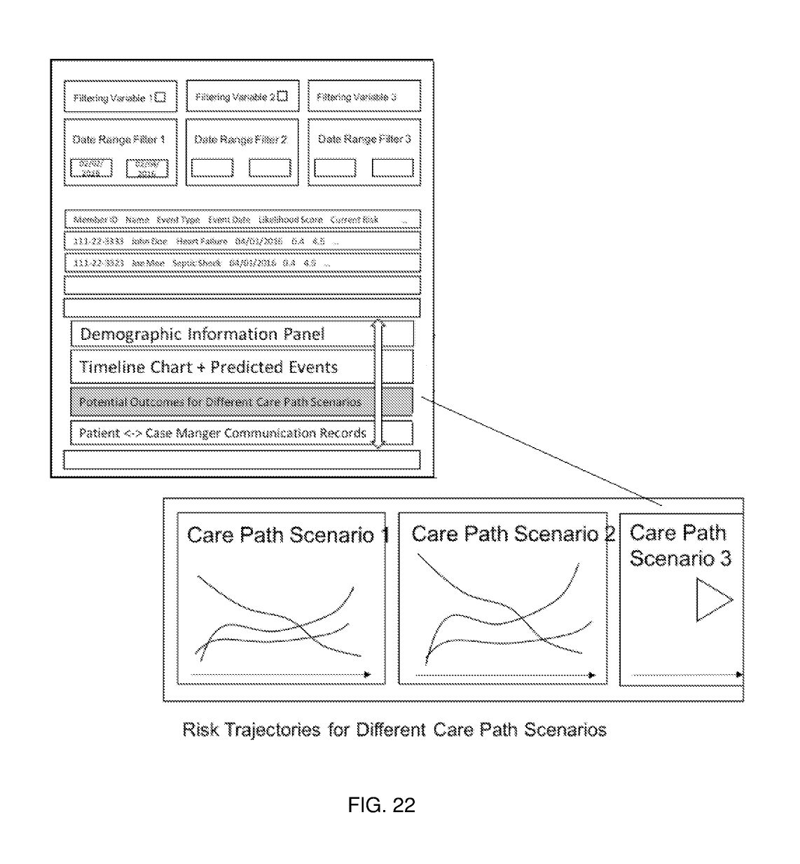

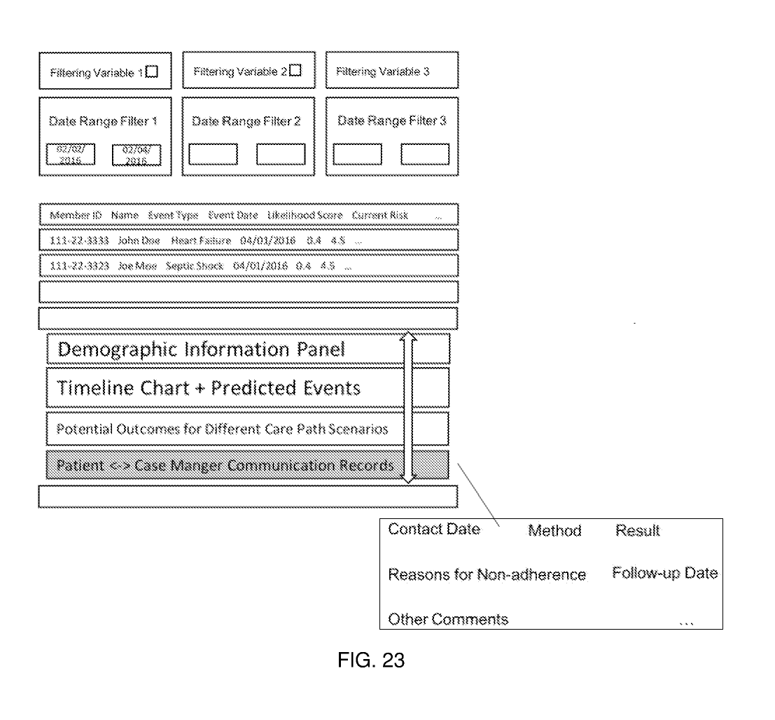

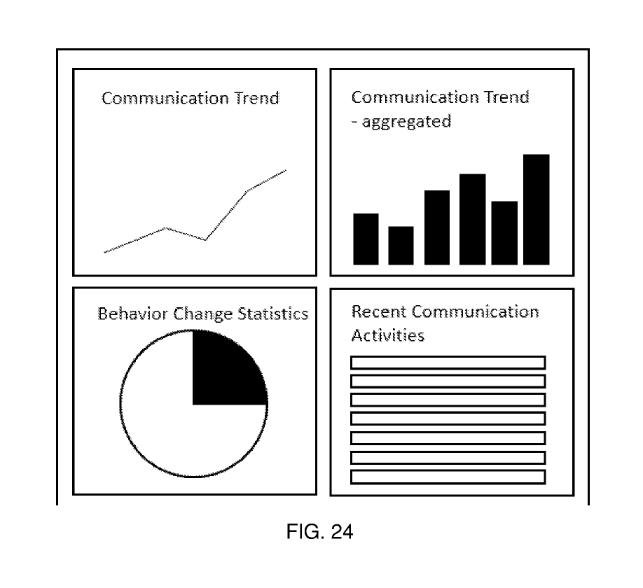

A representative case manager user interface is depicted in FIG. 18 through FIG. 24. In particular, FIG. 18 depicts a web interface for the case management tool by which a case manager may generate a customized chase list of patients as generated by the forecast engine. FIG. 19 depicts how a given row in the chase list may be selected to reveal additional options. FIG. 20 depicts a demographic information display panel in the web interface. FIG. 21 depicts a timeline view of a display panel of predicted events for the patient as generated by the forecast engine. FIG. 22 depicts a display panel showing predicted outcomes for different care path scenarios for the patient as generated by the forecast engine. FIG. 23 depicts a display panel by which a case manager can enter information captured during member communications. FIG. 24 depicts a usage dashboard by which a case manager can review trends, statistics, reports, and the like. These display panels are merely representative of the case management system user interface.

It is not required that the case management UI be web-based. The case manager tool may operate with a mobile device or other Internet-of-Things (IoT) appliance or device to provide the case management user interface. Thus, for example, a case management system may provide a mobile app that is installed on a case manager or member mobile device and by which one or more information displays may then be provided based on the information generated by the forecast engine.

The techniques of this disclosure provide significant advantages. They enable case management tools and systems to operate more efficiently and accurately by providing much more useful information to the case manager or other user. Using the member-level view and the feature extraction based on rolling windows, the system predicts major events (e.g., inpatient events) with a high precision. The engine outputs a list of likely events in a next prediction period (e.g., with probability scores). By ordering members by these scores, the case manager can stratify members at-risk. Health Plans can use this system to prevent potential hospitalization, e.g., by contacting and proactively managing risky members, and thus to prevent readmissions. By using facility-based or physician-based cohorts, the system can also simulate and compare the performances e.g. complication rate simulation. By using facility-based or physician-based cohorts, the system also can be used to find better matching between patients and physicians (or facilities).

The forecast engine can be applied to various domains. As noted, one direct application is patient targeting. Using the engine, the case manager can identify a subset of population who will likely go through a certain medical event e.g. surgery or disease. The engine also provides different forecasting results calibrating user's demographic and medical history information. The engine forecasts the next events and the “time” of the events.

The above identified use cases are merely representative.

Each above-described process preferably is implemented in computer software as a set of program instructions executable in one or more processors, as a special-purpose machine.

Representative machines on which the subject matter herein is provided may be Intel Pentium-based computers running a Linux or Linux-variant operating system and one or more applications to carry out the described functionality. One or more of the processes described above are implemented as computer programs, namely, as a set of computer instructions, for performing the functionality described.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be a particular machine that is specially constructed for the required purposes, or it may comprise a computer otherwise selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. The functionality may be built into the name server code, or it may be executed as an adjunct to that code. A machine implementing the techniques herein comprises a processor, computer memory holding instructions that are executed by the processor to perform the above-described methods.

While given components of the system have been described separately, one of ordinary skill will appreciate that some of the functions may be combined or shared in given instructions, program sequences, code portions, and the like.

Preferably, the functionality is implemented in an application layer solution, although this is not a limitation, as portions of the identified functions may be built into an operating system or the like.

The functionality may be implemented with any application layer protocols, or any other protocol having similar operating characteristics.

There is no limitation on the type of computing entity that may implement the client-side or server-side of the connection. Any computing entity (system, machine, device, program, process, utility, or the like) may act as the client or the server.

While given components of the system have been described separately, one of ordinary skill will appreciate that some of the functions may be combined or shared in given instructions, program sequences, code portions, and the like. Any application or functionality described herein may be implemented as native code, by providing hooks into another application, by facilitating use of the mechanism as a plug-in, by linking to the mechanism, and the like.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

As noted, the functionality may be co-located or various parts/components may be separately and run as distinct functions, in one or more locations (over a distributed network).

The techniques herein generally provide for the above-described improvements to a technology or technical field (namely, event-based forecasting methods), as well as the specific technological improvements to other industrial/technological processes (e.g., existing case management systems, tools and devices).

What is claimed is as follows:

1. A method of case management, comprising:
predicting one or more future events and their anticipated timing for patients by:
receiving and merging disparate health episode data sets into patient-specific data objects, wherein a patient-specific data object is a collection of episodes associated with the patient;
from the patient-specific data objects, processing a patient population into one or more cohorts, wherein a cohort is associated with one or more dynamic features whose values depend on one or more observation periods, each observation period defined by a rolling window;
applying one or more rolling windows to the one or more cohorts to extract one or more of the dynamic features; and
applying machine learning using the one or more dynamic features extracted to generate predictions for the one or more future events and their anticipated timing; and
providing the predictions to drive a case management operation.

2. The method as described in claim 1 wherein the case management operation generates a chase list of patients to be contacted by a case manager.

3. The method as described in claim 1 wherein the case management operation outputs a timeline indicating the one or more future events and their anticipated timing.

4. The method as described in claim 1 wherein the case management operation outputs potential outcomes for different care path scenarios for a patient.

5. The method as described in claim 1 wherein the case management operation outputs a tree diagram to visualize forecasted medical pathways based on one or more input constraints associated with a patient.

6. The method as described in claim 1 wherein, in addition to predicted values for future events, the machine learning also generates additional information.

7. The method as described in claim 6 wherein the additional information includes one or more machine learning model parameters, and other data that is one of: a transition probability between future events, drift momentum data, and a latent representation of a time series associated with a rolling window.

8. The method as described in claim 1 wherein predicting the one or more future events further includes blending predictions generated from at least first and second machine learning algorithms to reduce bias.

9. The method as described in claim 8 wherein predicting the one or more future events further includes validating the blended predictions.

10. The method as described in claim 9 wherein predicting the one or more future events further includes adjusting a cohort definition based on a result of a validation of the blended predictions.

11. The method as described in claim 9 wherein predicting the one or more future events further includes adjusting a machine learning model parameter based on a result of a validation of the blended predictions.

12. The method as described in claim 1 further including augmenting a patient-specific data object to include a cohort of which the patient has been determined to be associated.

13. Apparatus for case management, comprising:
a case management system comprising one or more computing machines, and a web-based user interface for display of case management-specific information; and
a forecast engine executing as software in one or more hardware processors, the forecast engine operative to:
receive and merge disparate health episode data sets into patient-specific data objects, wherein a patient-specific data object is a collection of episodes associated with the patient;
from the patient-specific data objects, process a patient population into one or more cohorts, wherein a cohort is associated with one or more dynamic features whose values depend on one or more observation periods, each observation period defined by a rolling window;
apply one or more rolling windows to the one or more cohorts to extract one or more of the dynamic features; and
apply machine learning using the one or more dynamic features extracted to generate predictions for the one or more future events and their anticipated timing; and
outputting information on the web-based user interface based on the predictions to provide an improved case management operation.

14. The apparatus as described in claim 13 further include a data store to store the patient-specific data objects.

15. The apparatus as described in claim 14 wherein the data store is non-relational document data store that stores the patient-specific data objects in JSON format.

16. The apparatus as described in claim 13 wherein the disparate health episode data sets are merged in the patient-specific data objects by a data transformation.

17. A product, comprising:
a non-transitory computer readable storage device; and
computer readable instructions stored by the storage device;
wherein the computer readable instructions include instruction sets respectively written to cause a computer to perform the following operations in association with a case management tool:
(a) receive and merge disparate health episode data sets into patient-specific data objects, wherein a patient-specific data object is a collection of episodes associated with the patient marking dynamic output from a first web application;
(b) from the patient-specific data objects, process a patient population into one or more cohorts, wherein a cohort is associated with one or more dynamic features whose values depend on one or more observation periods, each observation period defined by a rolling window;
(c) apply one or more rolling windows to the one or more cohorts to extract one or more of the dynamic features; and
(d) apply machine learning using the one or more dynamic features extracted to generate predictions for the one or more future events and their anticipated timing.

18. The product of claim 17 further comprising a set of computer(s), wherein the set of computer(s) is operatively connected to the storage device so that the set of computer(s) can perform the operations respectively associated with instruction sets (a), (b), (c) and (d).

19. A method for forecasting in association with case management, comprising:
receiving and merging disparate health episode data sets into patient-specific data objects, wherein a patient-specific data object is a collection of episodes associated with the patient;
from the patient-specific data objects, processing a patient population into one or more cohorts, wherein a cohort is associated with one or more dynamic features whose values depend on one or more observation periods, each observation period defined by a rolling window;
applying one or more rolling windows to the one or more cohorts to extract one or more of the dynamic features;
applying machine learning using the one or more dynamic features extracted to generate predictions for the one or more future events and their anticipated timing;
validating the predictions; and
based on results of validating the predictions, taking an action that is one of: adjusting a definition of a cohort, and adjusting a machine learning model.

20. The method as described in claim 19 further including blending predictions generated from two or more machine learning models prior to validation.
